(19) United States
(12) Patent Application Publication
(10) Pub. No.: US 2015/0169901 A1
(43) Pub. Date: Jun. 18, 2015

(54) Method and Systems for Integrity Checking a Set of Signed Data Sections

(71) Applicant: SanDisk Technologies Inc., Plano, TX (US)

(72) Inventor: Steve Karouby, Nahariya (IL)

(73) Assignee: SanDisk Technologies Inc., Plano, TX (US)

(21) Appl. No.: 14/104,834

(22) Filed: Dec. 12, 2013

(51) Int. Cl. G06F 21/64; G06F 17/30

(52) U.S. Cl. CPC G06F 21/64; G06F 17/30091

(57) ABSTRACT

Method and systems for integrity checking a set of signed data sections are disclosed. In one embodiment, for each of a plurality of data sections, a digital signature is generated based both on the data for that section and on common data for a set of data sections, even if the common data is stored in another section. The digital signature is stored in that section. For each section, a digital signature is generated based both on the data for that section and on the common data. The generated digital signature is compared with the stored digital signature in that section, and the integrity of the set is verified if the generated digital signature matches the stored digital signature for each section in the set.

### BACKGROUND

To ensure integrity of data, a digital signature can be generated and stored for the data (e.g., using a key-based message authentication code algorithm, such as a hash-based message authentication code-secure hash algorithm (HMAC-SHA)). To determine if the data has been tampered with, a signature for the data is again generated, and the newly-generated signature is compared with the stored signature to see if there is a match. Since there will only be a match if the data has not been tampered with, data integrity is verified if the signatures match.

In some environments, data is divided into a plurality of sections, and each section is individually signed. In such environments, it is not only desired to ensure the integrity of each individually-signed section, but it may also be desired to ensure the integrity of the set itself (i.e., that all the individually-signed sections in the set actually belong to the set). While the digital signature of each section ensures the integrity of that particular section, it does not indicate whether or not that particular section is grouped correctly with other digitally-signed sections in a set. So, even if each individual section of a set passes its integrity check, one or more of the sections of the set may have been exchanged with section(s) from a different set. This can be disadvantageous, especially if the sections were exchanged by a hacker to introduce a virus or other malware into the set.

### Overview

Embodiments of the present invention are defined by the claims, and nothing in this section should be taken as a limitation on those claims.

By way of introduction, in one embodiment, a method for providing an integrity check for a set of data sections is disclosed. Common data is stored for a first set of data sections in one of a plurality of data sections of the first set. For each of the plurality of data sections in the first set, a digital signature is generated based both on the data for that section and on the common data for the first set, even if the common data for the first set is stored in another section, and the digital signature is stored in that section. In one implementation, this method is performed in a host device in communication with a storage module, which can be embedded in the host device or can be removable from the host device. In another implementation, this method is performed in a component in a network cloud. Other implementations can be used.

In another embodiment, a method for integrity checking a set of signed data sections is disclosed. Common data is read for a first set of data sections from one of a plurality of data sections, wherein each of the data sections stores a digital signature for that section. For each of the plurality of data sections, a digital signature is generated based both on the data for that section and on the common data for the first set, even if the common data for the first set is stored in another section, and the generated digital signature is compared with the stored digital signature in that section. Integrity of the first set is verified if the generated digital signature matches the stored digital signature for each section. In one implementation, this method is performed in a storage module in communication with a host device. The storage module can be embedded in the host device or can be removable from the host device. In another implementation, this method is performed in a component in a network cloud. Other implementations can be used.

Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary storage module of an embodiment.

FIG. 2A is a block diagram of a host of an embodiment, where the exemplary storage module of FIG. 1 is embedded in the host.

FIG. 2B is a block diagram of the exemplary storage module of FIG. 1 removably connected to a host, where the storage module and host are separable, removable devices.

FIG. 2C is a block diagram showing one implementation of these embodiments in a component in a network cloud.

FIG. 3 is an illustration of a plurality of signed data sections of an embodiment.

FIG. 4 is an illustration of a method of an embodiment for checking the integrity of a plurality of signed data sections by computing a signature of the signatures in an extra section.

FIG. 5 is an illustration of a method of an embodiment for checking the integrity of a plurality of signed data sections by computing a signature of the signatures in an existing section.

FIG. 6 is an illustration of a method of an embodiment for checking the integrity of a plurality of signed data sections by computing a signature of the signatures in a last section and adding all the sections' signatures to it.

FIG. 7 is an illustration of a method of an embodiment for checking the integrity of a plurality of signed data sections by encrypting the sections after signing and then chaining one section to another.

FIG. 8 is an illustration of a method of an embodiment for checking the integrity of a plurality of signed data sections by using common data.

FIG. 9 is a flow chart of a method of an embodiment for signing data.

FIG. 10 is a flow chart of a method of an embodiment for verifying data.

### DETAILED DESCRIPTION OF THE PRESENTLY PREFERRED EMBODIMENTS

As mentioned above, while a digital signature can be used to ensure the integrity of a section of data, it does not indicate whether or not that particular section is grouped correctly with other digitally-signed sections in a set. While several methods can be used to address this problem, many of them require that a storage module have the ability to store data or perform advanced encryption functions, which might not be possible if the set of data to be checked by the storage module contains the basic firmware that the storage module needs to perform such functions. Embodiments are provided herein to ensure the integrity of a set of signed data sections without such functions. For example, in one embodiment, the digital signature of a section is generated based both on the data for that section and on the data that is common to all of the sections in the set. By introducing such “common data” into the digital signature, the digital signature for a given section will both ensure the integrity of that section and of the set as a whole.

Before turning to these and other embodiments, the following paragraphs provide a discussion of an exemplary storage module and host device that can be used with these embodiments. Of course, these are just examples, and other suitable types of storage modules and host devices can be used.

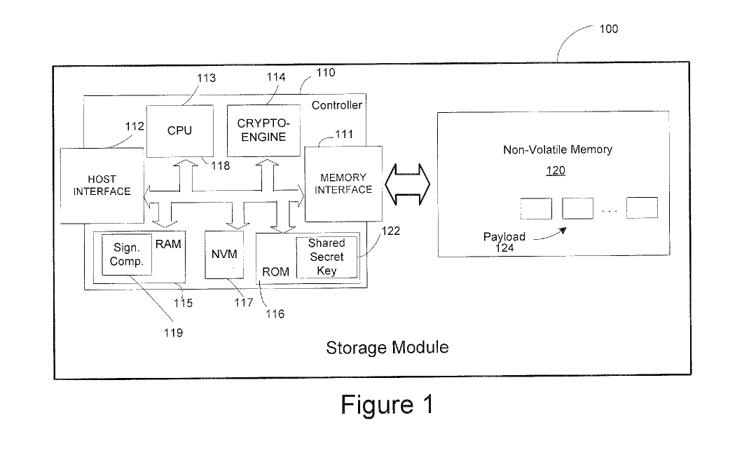

As illustrated in FIG. 1, a storage module 100 of one embodiment comprises a controller 110 and non-volatile memory 120. The controller 110 comprises a memory interface 111 for interfacing with the non-volatile memory 120 and a host interface 112 for placing the storage module 100 operatively in communication with a host controller. As used herein, the phrase “operatively in communication with” could mean directly in communication with or indirectly in communication with through one or more components, which may or may not be shown or described herein.

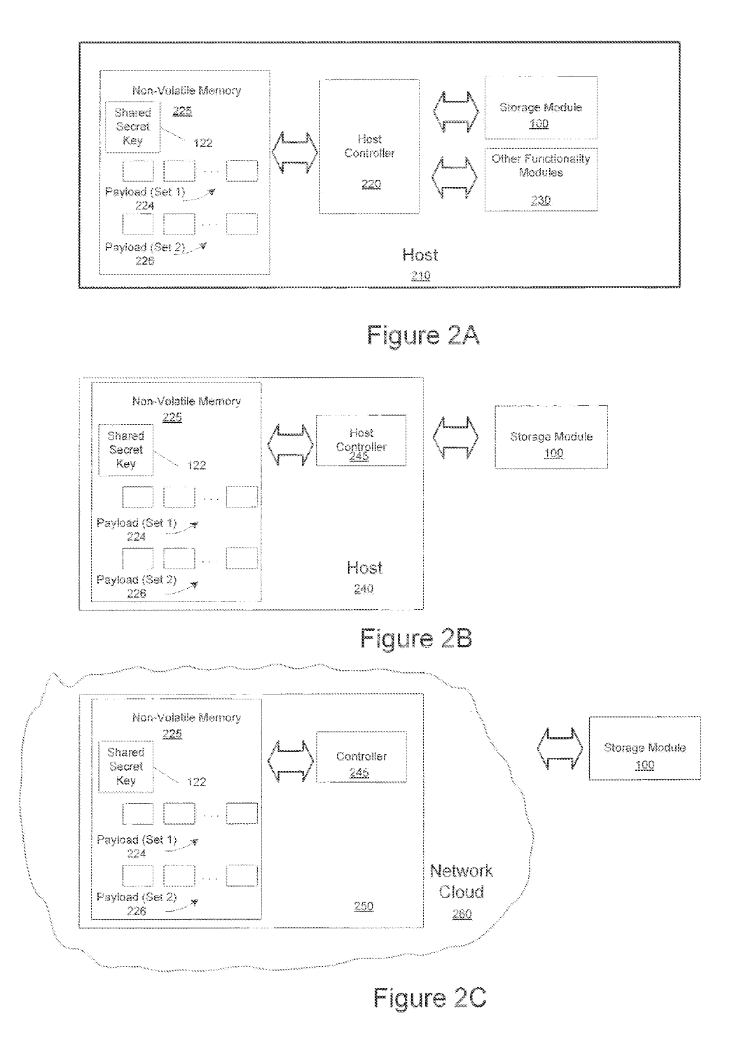

As shown in FIG. 2A, the storage module 100 can be embedded in a host 210 having a host controller 220. That is, the host 210 embodies the host controller 220 and the storage module 100, such that the host controller 220 interfaces with the embedded storage module 100 to manage its operations. For example, the storage module 100 can take the form of an iNAND™ eSD/eMMC embedded flash drive by SanDisk Corporation. The host controller 220 can interface with the embedded storage module 100 using, for example, an eMMC host interface or a UFS interface. The host 210 can take any form, such as, but not limited to, a solid state drive (SSD), a hybrid storage device (having both a hard disk drive and a solid state drive), a memory caching system, a mobile phone, a tablet computer, a digital media player, a game device, a personal digital assistant (PDA), a mobile (e.g., notebook, laptop) personal computer (PC), or a book reader. When the host device is used to provision a storage module with firmware, the host device can take the form of a general purpose computer or a specialized computer and may have an interface to allow it to program several storage modules in parallel. As shown in FIG. 2A, the host 210 can include optional other functionality modules 230. For example, if the host 210 is a mobile phone, the other functionality modules 230 can include hardware and/or software components to make and place telephone calls. As another example, if the host 210 has network connectivity capabilities, the other functionality modules 230 can include a network interface. Of course, these are just some examples, and other implementations can be used. Also, the host 210 can include other components (e.g., an audio output, input-output ports, etc.) that are not shown in FIG. 2A to simplify the drawing.

As shown in FIG. 2B, instead of being an embedded device in a host, the storage module 100 can have physical and electrical connectors that allow the storage module 100 to be removably connected to a host 240 (having a host controller 245) via mating connectors. As such, the storage module 100 is a separate device from (and is not embedded in) the host 240. In this example, the storage module 100 can be a handheld, removable memory device, such as a Secure Digital (SD) memory card, a microSD memory card, a Compact Flash (CF) memory card, or a universal serial bus (USB) device (with a USB interface to the host), and the host 240 is a separate device, such as a mobile phone, a tablet computer, a digital media player, a game device, a personal digital assistant (PDA), a mobile (e.g., notebook, laptop) personal computer (PC), or a book reader, for example.

In FIGS. 2A and 2B, the storage module 100 is in communication with a host controller 220 or host 240 via the host interface 112 shown in FIG. 1. The host interface 112 can take any suitable form, such as, but not limited to, an eMMC host interface, a UFS interface, and a USB interface. The host interface 112 in the storage module 110 conveys memory management commands from the host controller 220 (FIG. 2A) or host 240 (FIG. 2B) to the controller 110, and also conveys memory responses from the controller 110 to the host controller 220 (FIG. 2A) or host 240 (FIG. 2B). Also, it should be noted that when the storage module 100 is embedded in the host 210, some or all of the functions described herein as being performed by the controller 110 in the storage module 100 can instead be performed by the host controller 220.

It should be noted that the methods discussed herein can, instead of being implemented in a host and/or storage module, be implemented in a component in a network cloud. FIG. 2C is an example of this where the previously-described elements in the host are in a computing device 250 (e.g., a server or other computing device) in a network cloud 260. (In FIGS. 2A and 2B, the computer device took the form of a host.) In this case, the computing device 250 in the network cloud 260 would be performing the functions described herein that are performed by the host. Likewise, in another implementation, the method performed by the storage module can be performed by a computing device in a network cloud.

In FIGS. 2A-2C, the host device and network component are shown to have a non-volatile memory 225 storing a shared secret key 122 and a two or more sets of payloads 224, 226 of a plurality of data sections. These components will be discussed in more detail below. Also, the below embodiments discuss the storage module or host device being configured to perform certain functions. It should be understood that such configuring can be done by programming the controllers of the storage module and host device to perform these functions. Again, instead of a host and storage module, a component in a network cloud can be used.

Returning to FIG. 1, the controller 110 comprises a central processing unit (CPU) 113, an optional hardware crypto-engine 114 operative to provide encryption and/or decryption operations, read access memory (RAM) 115, read only memory (ROM) 116 which can store firmware for the basic operations of the storage module 100, and a non-volatile memory (NVM) 117. (A shared secret key 122 is shown stored in ROM 116 (to prevent its modification), and a signature computation component 119 (which is computer-readable program code) is shown in RAM 115. These components will be discussed in more detail below.) The controller 110 can be implemented in any suitable manner. For example, the controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Suitable controllers can be obtained from SanDisk or other vendors. Also, some of the components shown as being internal to the controller 110 can also be stored external to the controller 110, and other component can be used. For example, the RAM 115 (or an additional RAM unit) can be located outside of the controller die and used as a page buffer for data read from and/or to be written to the memory 120.

The non-volatile memory 120 can also take any suitable form. For example, in one embodiment, the non-volatile memory 120 takes the form of a solid-state (e.g., flash) memory and can be one-time programmable, few-time programmable, or many-time programmable. The non-volatile memory 120 can also use single-level cell (SLC), multiple-level cell (MLC), triple-level cell (TLC), etc. The non-volatile memory 120 can take the form of NAND Flash memory or of other memory technologies, now known or later developed. The non-volatile memory 120 can be used to store user or other data. FIG. 1 shows the non-volatile memory 120 storing a payload of sections of data 124, which will be discussed in more detail below.

As noted above, a digital signature can be generated and stored for data to ensure integrity of the data. A digital signature can be generated, for example, using a key-based message authentication code algorithm, such as a hash-based message authentication code secure hash algorithm (HMAC-SHA), although other techniques can be used. In cryptography, a keyed-hash message authentication code (HMAC) is a specific construction for calculating a message authentication code (MAC) involving a cryptographic hash function in combination with a secret cryptographic key. As with any MAC (message authentication code), the HMAC secret key may be used to simultaneously verify both the data integrity and the authentication of a message. Any cryptographic hash function, such as MD5 or SHA-1, may be used in the calculation of an HMAC; the resulting MAC algorithm is termed HMAC-MD5 or HMAC-SHA1 accordingly. The cryptographic strength of the HMAC depends upon the cryptographic strength of the underlying hash function, the size of its hash output, and on the size and quality of the key.

To determine if the data has been tampered with, a signature for the data is again generated, and the newly-generated signature is compared with the stored signature to see if there is a match. Since there will only be a match if the data has not been tampered with, data integrity is verified if the signatures match. If the signatures do not match, the data has been tampered with.

While the digital signature of each section ensures the integrity of that particular section, it does not indicate whether or not that particular section is grouped correctly with other digitally-signed sections in a set. If a section of data from one set is swapped out for a section of data from another set, a problem can occur, even if neither of the sections themselves has been tampered with. For example, during the manufacturing of storage modules, such as memory cards and embedded or removable solid-state drives, for example, a host provisions the storage module with firmware in order for the storage module to operate. The host can be used to provision several different types of storage modules and, thus, can contain several different sets of firmware. This is shown in FIGS. 2A and 2B with the host storing two payloads 224, 226 of two different sets of firmware. Each of these sets of firmware contains a plurality of digitally-signed sections of data intended for that particular set of firmware, and it is desired to ensure that a given set of sections being sent to a storage module actually contains all of the intended sections. Otherwise, a hacker can swap out one section of data for a section that will introduce a virus or other problem into the storage module. The digital signature of each section will not detect such tampering of the set, since it is designed only to detect tampering of an individual section.

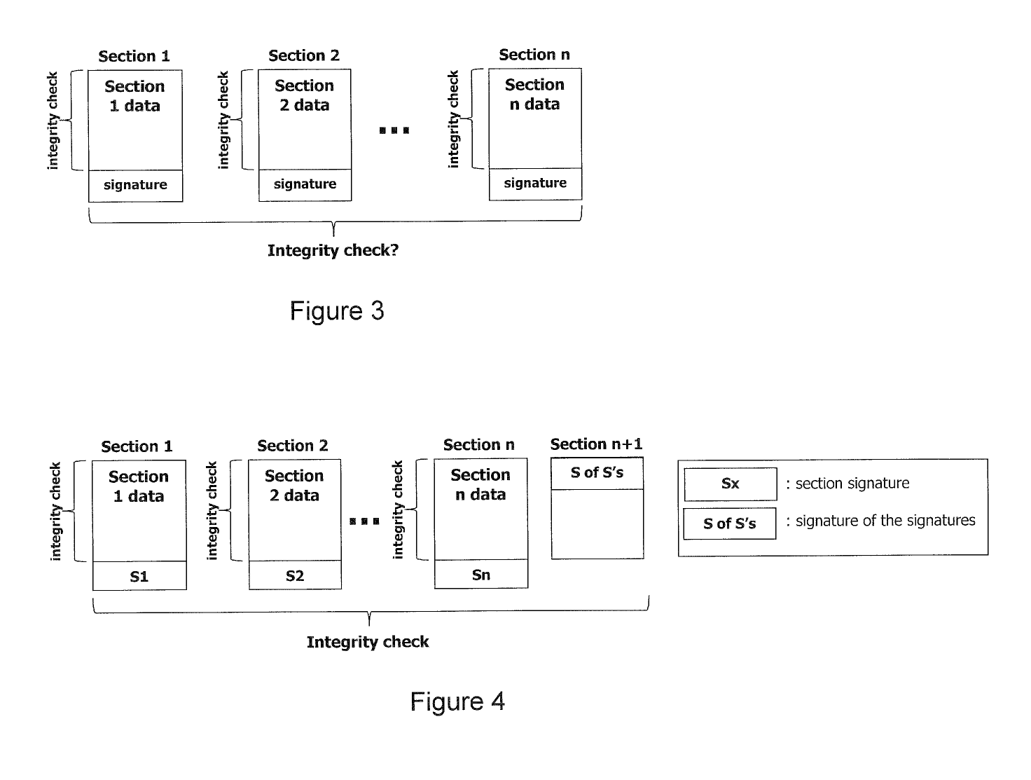

This problem is illustrated in FIG. 3. As shown in FIG. 3, each section of data in the set of n sections has a signature associated with it. So, each signature can be used to detect if its associated section of data has been tampered with. However, since the signature for any given section only ensures the integrity of that section, the signature does not indicate whether or not that section belongs with the other sections in the set. That is, Section 2, for example, may actually belong to a different set of data. Assuming that the data itself in Section 2 has not been tampered with, the signature of Section 2 will indicate the integrity of Section 2 but will not indicate that it is, in fact, data from a different set.

FIGS. 4-7 show several methods that can be used to ensure integrity of a set of digitally-signed sections of data (i.e., to check the integrity of all the sections considered as part of a set to prevent section exchange). For example, FIG. 4 illustrates a method for checking the integrity of a plurality of signed data sections by computing a signature of the signatures of all the sections, and then putting that “signature of the signatures” in an extra section (section n+1). In one embodiment, the signature of the sections' signatures is computed by applying the same message authentication code algorithm as the one used to sign one section (although a different message authentication code algorithm can be used), to a concatenation of all the signatures. This approach solves the problem noted above since the integrity of the set of sections can be checked by computing and matching the signature of the signatures (“S of S's”). That is, if one of the sections in the set has been exchanged with a section from another set, the computed signature of the signatures will not match the stored signature of the signatures. However, an extra section is needed in this method, and one extra signature needs to be computed. Moreover to calculate the signature of the signatures, each section signature needs to be temporarily stored. Both of these requirements may be challenging in certain environments. For example, before the firmware is provision in the storage module, the storage module may not yet be configured with the ability to store data, which ability would be needed to temporarily store the signature of the signatures. Also, as noted above, an extra section is needed in this approach, which consumes memory and adds to overhead.

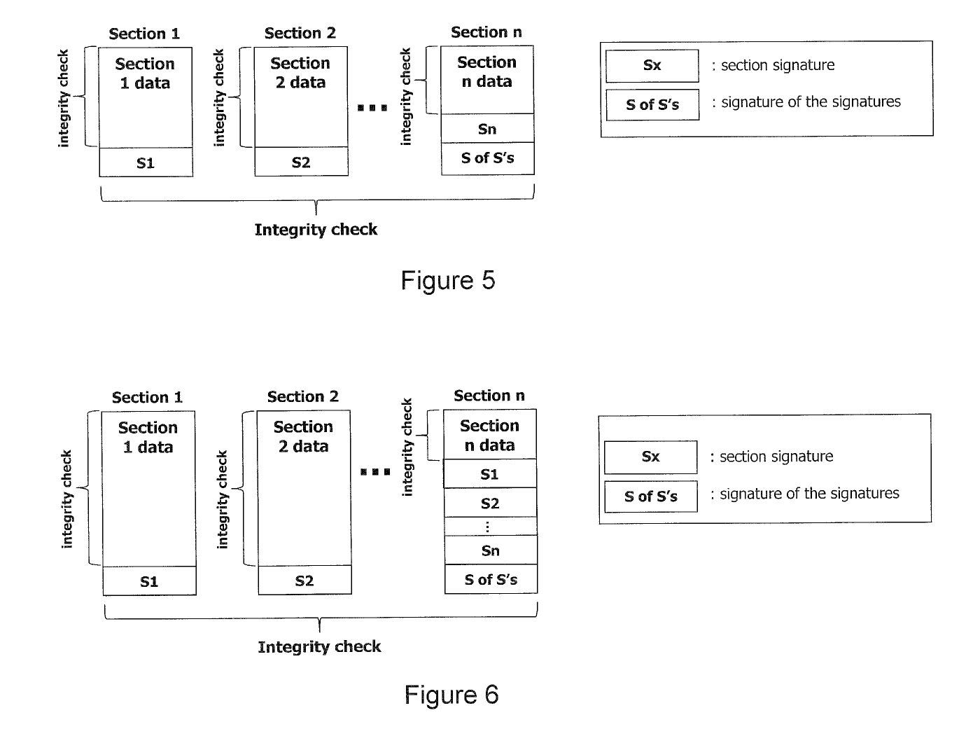

In another method, shown in FIG. 5, a signature of the signatures is computed in an existing section (in this example, the signature of the signatures is stored in Section n, although it can be stored in any section). As with the approach shown in FIG. 4, this approach also solves the problem of checking the integrity of the entire set of sections. However, as also with the approach shown in FIG. 4, this approach requires an extra signature, and each section signature needs to be stored in order to generate the signature of the signatures. Again, this can be a problem with storage modules that are not yet configured with firmware enabling the storage module to store data.

In the method shown in FIG. 6, a signature of the signatures is computed and stored in a last section of the set, along with all of the other sections' signatures. This approach removes the need to keep each section signature in order to generate the signature of the signatures. Indeed, each section signature is stored in the last section together with the signature of the signatures. However, this method does not solve the “set integrity” problem, since any signed section of the set can be exchanged with another signed section from another set. That is, the signature of the signatures is useful only to check the last section. Moreover, here again, one extra signature is needed.

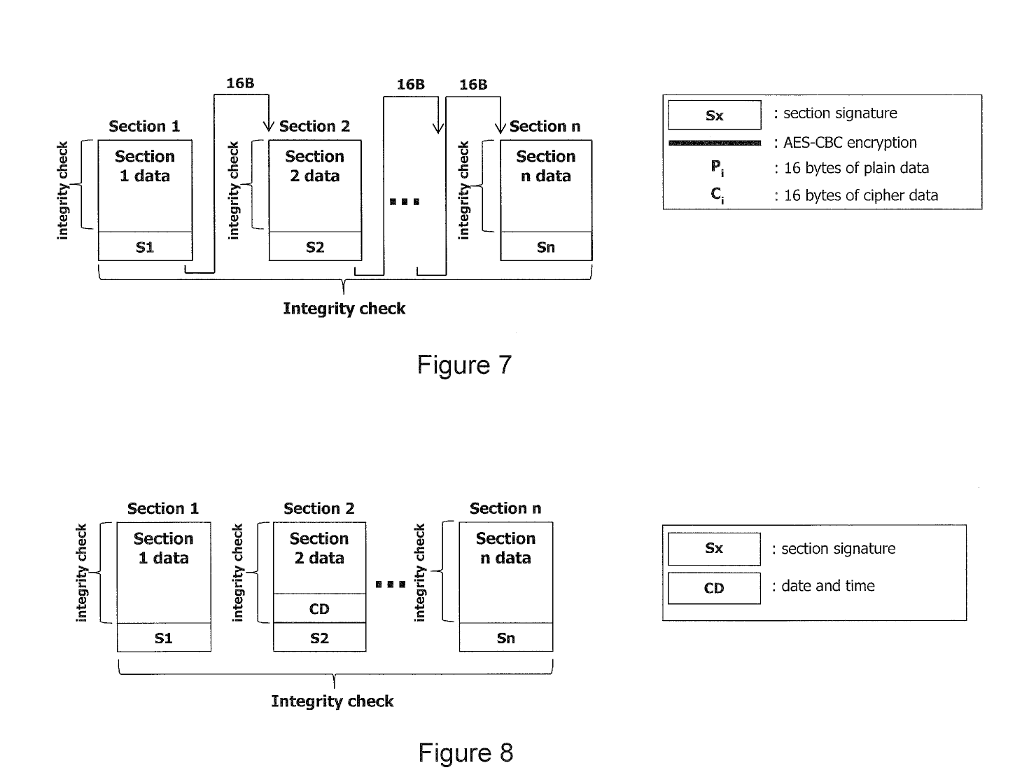

In the method shown in FIG. 7, the integrity of a plurality of signed data sections in a set is ensured by encrypting the sections after signing and then chaining one section to another. An encryption algorithm, such as the Advanced Encryption Standard (AES) algorithm, in cipher block chaining (CBC) mode, can be used after signing each of the sections. In encryption notation: Cᵢ=E(Pᵢ⊕Cᵢ₋₁), C₀=IV, where Cᵢ is 16 bytes of cipher data, Pᵢ is 16 bytes of plain data, and IV is the initialization vector.

This encryption algorithm allows each 16-byte block of section data to be linked to the previous one. This prevents a section from being exchanged with a section from a different set because each section in the set is linked together. That is, the integrity of the set of sections is done by decrypting the sections and then checking each section signature. If a section from the set is exchanged with a section from another set, that section's decryption will lead to garbage data, and its integrity check will fail. However, for this approach, the storage module would need to be enabled with encryption functionality, which may not be the case when the storage module has not yet received its basic firmware.

The following embodiments can be used to provide an integrity check of a set of data sections without the disadvantages of the other methods discussed above. In one embodiment, the digital signature of a section is generated based both on the data for that section and on data that is common to all of the sections in the set. By introducing such “common data” into the digital signature, the digital signature for a given section will both ensure the integrity of that section and of the set as a whole.

In this embodiment, the host generates or computes common data (CD) and then adds this common data to one or more of the data sections of the set of data (the “payload”) for data integrity checks purposes. The common data can take any suitable form. In one embodiment, the common data is associated with the multiple data sections of the payload in some manner. For example, the common data can be the date and time of the creation of the sections or the compilation time of the sections (e.g., when the host compiled the firmware) (as in the example shown in FIG. 8). The common data can, instead, be independent of the data, such as when a random number is used, which may provide stronger security since the common data is not derived from the data. Regardless of how it is generated, it is preferred that the common data be unique for each set of data sections at issue, so as to provide a suitable way to ensure integrity of a given set to prevent a section of one set from being exchanged with a section of another set.

The common data can be placed in any suitable location in the payload 124 by the host device. In one embodiment, the common data is placed in a pre-defined location in a pre-defined data section of the payload by the host device, so the storage module 100 will know where to look for the common data. For example, the common data can be added to a fixed offset in a pre-defined data section at the beginning of the payload. As another example, the common data can be placed prior to the signature of a section, as shown in FIG. 8. Of course, these are merely examples, and the common data can be stored in any other fixed location. In another embodiment, rather than storing the common data in a fixed location, the common data is placed in an arbitrary location that is communicated to or derived by the storage module 100. In yet another embodiment, the common data is communicated to the storage module 100 outside of the set of data (e.g., in a separate transmission).

Although the common data is used to compute each of the section's signatures, the common data only needs to be stored in one of the sections, since, after the storage module 100 reads the common data from one of the sections, it can use that common data in the signature computation of each of the other sections. So, in the example shown in FIG. 8, the common data is only stored once (in Section 2). However, in other embodiments, the common data is stored in more than one data section or even all of the data sections. If fewer than all of the sections store common data, the various sections can be of different sizes (e.g., the section(s) that hold the common data can be larger than the sections that do not store the common data), or all of the sections can be of the same size, with the location of the sections that do not carry the common data being filled with zeros or other data. Regardless of how many times the common data is stored, it should be noted that, in this embodiment, the common data is stored together with the data from the sections (e.g., the firmware data from the host) and not in a separate or additional section (i.e., an extra data section does not need to be allocated to hold the common data).

As noted above, in creating the signatures for each of the individual sections, the common data (CD) is included along with the data from that section in the signature calculation—even if the common data is not stored in that section (i.e., even if the common data is stored in another section). That is, the host device know what the common data is and can introduce it into the signature calculation, so the common data does not have to be physically present in that section. After the host signs the sections of data of a set as specified above (e.g., using the shared secret key), the host sends the sections of the set to the storage module 100, which stores the sections (referred to as “payload 124” in FIG. 1) in the non-volatile memory 120. After the storage module 100 receives the payload 124, it executes the signature computation code 119 in order to generate a digital signature for each section of the payload 124 (e.g., using the shared secret key 122 stored in the storage module 100) and then compares the generated signature with the signature stored in each of the sections. (In one embodiment, the shared secret key 122 is stored in the controller's ROM 116, to make it more secure since that area is typically protected from modification.) Because the signature of each section is based in part on data that was common to each of the sections of the set when the signature was initially generated, if any of the sections from the set were exchanged with sections from a different set, the signatures will not match, thus ensuring integrity of the set of sections provided to the storage module 100. Thus, generating different data signatures based on common data (CD) allows for checking of the data integrity of the multiple data sections on the payload as a whole and detects any attempt to exchange a signed section from the set with a signed section from another set. This integrity check of the set of sections is done without disadvantages of the other methods discussed above (e.g., computing an extra signature, storing additional data, using an additional section to store signatures, or using chain encryption).

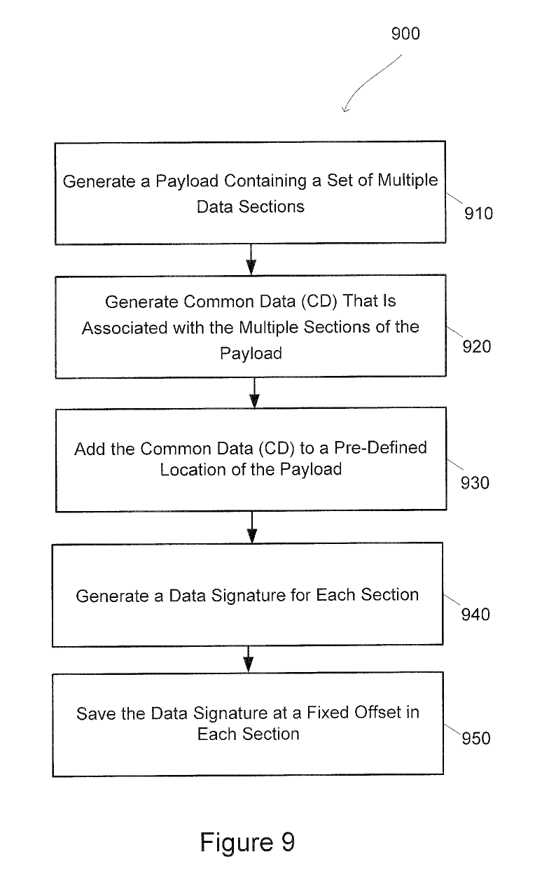

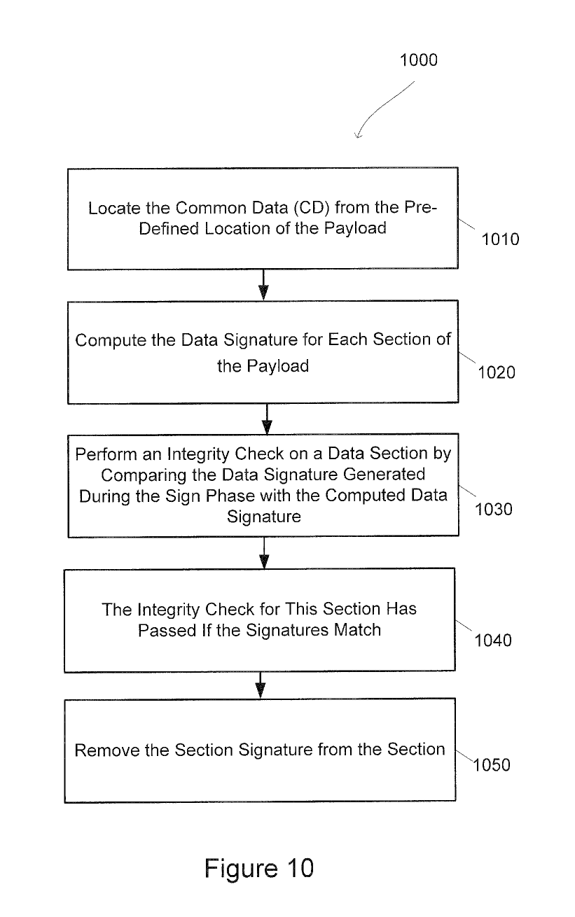

Returning to the drawings, FIGS. 9 and 10 illustrate the signing and verifying phases of the host device and storage module 100, respectively, in more detail. FIG. 9 is a flow chart 900 of a method of an embodiment for signing data. In one embodiment, this method is performed by the host providing a payload of data to the storage module 100. As shown in FIG. 9, the host generates a payload containing a set of multiple data sections (act 910). The host then generates (or, alternatively, receives from an outside source) common data (CD) that is associated with the multiple sections of the payload (act 920). The common data is generated per payload, so each payload (set) has its own unique common data. The host then adds the common data (CD) to a pre-defined location of the payload (act 930). (As noted above, in other embodiments, instead of being stored in a pre-determined location, the common data can be placed in an arbitrary location that is later communicated to or derived by the storage module 100).

Next, the host generates a data signature for each section (act 940). In one embodiment, the section's data signature is generated by signing the concatenation of the section data with the common data (CD) by carrying out a hash-based message authentication code (HMAC) that utilizes a shared secret key (e.g., key 122). Where HMAC is used to generate the signature, the signature computation for each section is applied to the concatenation of the section data and the common data (CD) as follows: Sx=HMAC ((Section×data+CD), Key), where “Sx” is the section signature, “CD” is the common data, and “Key” is the shared secret key 122. The shared secret key 122 used for HMAC is a fixed shared secret key 122 that can be specific to the device's type and firmware design and can be located at a proprietary location in the RAM code of the device. The shared secret key 122 is “shared” in the sense that both the host and the storage module know the value of the key.

Finally, the host then saves the data signature in each section (e.g., at a fixed offset at the end of each section) (act 950). As noted above, the data signature obtained for each section is not regarded as part of the section data. The host then provides the signed sections of the set (the payload 124) to the storage module 100. In one embodiment, the payload 124 is the firmware needed for the storage module 100 to run and is provisioned during the manufacturing of the storage module 100. The payload 124, which in this embodiment is divided into multiple data sections, can be stored in any suitable location in the storage module 100, such as in the non-volatile memory 120 (as in FIG. 8) or in RAM 115. (As noted above, the various sections can be of the same size or different sizes.) In this example, the storage module 100 does not yet have the functionality to generate digital signatures based on data (which is needed in the verification phase discussed below), so the host also provides the storage module with signature computation code 119, which the storage module 100 stores in RAM 115 for execution by the CPU 113.

FIG. 10 is a flow chart 1000 of a method of an embodiment for verifying data, which, in one embodiment, is performed by the storage module 100 after it receives the payload from the host. First, the storage module 100 locates the common data (CD) from a known offset in a pre-defined data section of the payload 124 (act 1010). (As discussed above, in other embodiments, the storage module 100 can use different techniques to find the common data.) The storage module 100 then computes the data signature for each section of the payload 124 by signing the concatenation of the section data and common data (act 1020). In one embodiment, this is done by executing the signature computation code 119 and then using the shared secret key 122 stored in the storage module 100 to generate the signature. Because the storage module 100 only needs to read the common data once, the common data can be stored in only one of the data sections. So, the storage module 100 can use this common data to calculate signatures of other data sections, even if the common data is not stored in those other data sections. Also, as noted above, the signature calculation can be performed using the shared secret key 122, which can be stored in any suitable location in the storage module 100, such as in the non-volatile mass storage memory 120 (e.g., in a proprietary memory location) (as in FIG. 8) or in the smaller non-volatile memory 117 in the controller 110, for example.

The storage module then performs an integrity check on a data section by comparing the data signature generated during the sign phase (act 940 in FIG. 9) with the computed data signature computed in act 1020 that is delivered with the payload 124 for this section (act 1030). The comparison check is performed per section. If the signatures match, the integrity check for that section passes (thereby authenticating that a section exchange scenario has not occurred) (act 1040), and the section signature may be removed from the section and replaced by zeros (act 1050). If the signatures do not match, the integrity check for this section has failed (e.g., because one correctly-signed section in the payload was exchanged for another correctly-signed section from another payload).

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A method for providing an integrity check for a set of data sections, the method comprising:
storing common data for a first set of data sections in one of a plurality of data sections of the first set; and
for each of the plurality of data sections in the first set:
generating a digital signature based both on the data for that section and on the common data for the first set, even if the common data for the first set is stored in another section; and
storing the digital signature in that section.

2. The method of claim 1, wherein the common data is stored in a pre-determined location in the one of the plurality of data sections.

3. The method of claim 1, wherein the common data is stored in only one of the plurality of data sections.

4. The method of claim 1, wherein the common data is stored in more than one of the plurality of data sections.

5. The method of claim 1, wherein each of the data sections has the same size.

6. The method of claim 1, wherein the data section that stores the common data for the first set is of a larger size than the other data sections.

7. The method of claim 1, wherein the common data for the first set is associated with the data in the plurality of data sections.

8. The method of claim 7, wherein the common data for the first set is a time of creation of the plurality of data sections.

9. The method of claim 1, wherein the common data for the first set is independent of the data of the plurality of data sections.

10. The method of claim 9, wherein the common data is a random number.

11. The method of claim 1, wherein the common data is common to the first set but not to a second set of data sections.

12. The method of claim 1, wherein the method is performed in a host device, and wherein the method further comprises providing the first set of data sections to a storage module in communication with the host device.

13. The method of claim 12, wherein the first set of data sections comprises firmware for the storage module.

14. The method of claim 12 further comprising providing the storage module with computer-readable program code to generate a digital signature.

15. The method of claim 12, wherein the digital signature is generated using a key that is shared between the host device and storage module.

16. The method of claim 12, wherein the storage module is embedded in the host device.

17. The method of claim 12, wherein the storage module is removably connected to the host device.

18. The method of claim 1, wherein the method is performed in a computing device in a network.

19. The method of claim 1, wherein the digital signature is generated using a hash-based message authentication code (HMAC).

20. A computing device comprising:
a memory storing a plurality of data sections belonging to a first set; and
a controller in communication with the memory, the controller configured to:
store common data for the first set in one of the plurality of data sections; and
for each of the plurality of data sections in the first set:
generate a digital signature based both on the data for that section and on the common data for the first set, even if the common data for the first set is stored in another section; and
store the digital signature in that section.

21. The computing device of claim 20, wherein the common data is stored in a pre-determined location in the one of the plurality of data sections.

22. The computing device of claim 20, wherein the common data is stored in only one of the plurality of data sections.

23. The computing device of claim 20, wherein the common data is stored in more than one of the plurality of data sections.

24. The computing device of claim 20, wherein each of the data sections has the same size.

25. The computing device of claim 20, wherein the data section that stores the common data for the first set is of a larger size than the other data sections.

26. The computing device of claim 20, wherein the common data for the first set is associated with the data in the plurality of data sections.

27. The computing device of claim 26, wherein the common data for the first set is a time of creation of the plurality of data sections.

28. The computing device of claim 20, wherein the common data for the first set is independent of the data of the plurality of data sections.

29. The computing device of claim 28, wherein the common data is a random number.

30. The computing device of claim 20, wherein the common data is common to the first set but not to the second set of data sections.

31. The computing device of claim 20, wherein the computing device is a host device, and wherein the controller is further configured to provide the first set of data sections to a storage module in communication with the host device.

32. The computing device of claim 31, wherein the first set of data sections comprises firmware for the storage module.

33. The computing device of claim 31, wherein the controller is further configured to provide the storage module with computer-readable program code to generate a digital signature.

34. The computing device of claim 31, wherein the digital signature is generated using a key that is shared between the host device and storage module.

35. The computing device of claim 31, wherein the storage module is embedded in the host device.

36. The computing device of claim 31, wherein the storage module is removably connected to the host device.

37. The computing device of claim 20, wherein the computing device is located in a network.

38. The computing device of claim 20, wherein the digital signature is generated using a hash-based message authentication code (HMAC).

39. A method for integrity checking a set of signed data sections, the method comprising:
reading common data for a first set of data sections from one of a plurality of data sections, wherein each of the data sections stores a digital signature for that section; and
for each of the plurality of data sections:
generating a digital signature based both on the data for that section and on the common data for the first set, even if the common data for the first set is stored in another section; and
comparing the generated digital signature with the stored digital signature in that section;
wherein integrity of the first set is verified if the generated digital signature matches the stored digital signature for each section.

40. The method of claim 39, wherein the common data is stored in a pre-determined location in the one of the plurality of data sections.

41. The method of claim 39, wherein the common data is stored in only one of the plurality of data sections.

42. The method of claim 39, wherein the common data is stored in more than one of the plurality of data sections.

43. The method of claim 39, wherein each of the data sections has the same size.

44. The method of claim 39, wherein the data section that stores the common data for the first set is of a larger size than the other data sections.

45. The method of claim 39, wherein the common data for the first set is associated with the data in the plurality of data sections.

46. The method of claim 45, wherein the common data for the first set is a time of creation of the plurality of data sections.

47. The method of claim 39, wherein the common data for the first set is independent of the data of the plurality of data sections.

48. The method of claim 47, wherein the common data is a random number.

49. The method of claim 39, wherein the method is performed in a storage module, and wherein the method further comprises receiving the first set of data sections from a host device in communication with the storage module.

50. The method of claim 49, wherein the host device stores a second set of data sections, and wherein the common data is common to the first set but not to the second set.

51. The method of claim 49, wherein the first set of data sections comprises firmware for the storage module.

52. The method of claim 49, wherein the storage module receives computer-readable program code from the host device to generate a digital signature.

53. The method of claim 49, wherein the digital signature is generated using a key that is shared between the host device and storage module.

54. The method of claim 49, wherein the storage module is embedded in the host device.

55. The method of claim 49, wherein the storage module is removably connected to the host device.

56. The method of claim 39, wherein the method is performed in a computing device in a network.

57. The method of claim 39, wherein the digital signature is generated using a hash-based message authentication code (HMAC).

58. A storage module comprising:
a memory storing a plurality of data sections of a first set, wherein each of the sections stores a digital signature for that section;
a controller in communication with the memory, the controller configured to:
read common data for the first set from one of the plurality of data sections; and
for each of the plurality of data sections:
generate a digital signature based both on the data for that section and on the common data for the first set, even if the common data for the first set is stored in another section; and
compare the generated digital signature with the stored digital signature in that section;
wherein integrity of the first set is verified if the generated digital signature matches the stored digital signature for each section.

59. The storage module of claim 58, wherein the common data is stored in a pre-determined location in the one of the plurality of data sections.

60. The storage module of claim 58, wherein the common data is stored in only one of the plurality of data sections.

61. The storage module of claim 58, wherein the common data is stored in more than one of the plurality of data sections.

62. The storage module of claim 58, wherein each of the data sections has the same size.

63. The storage module of claim 58, wherein the data section that stores the common data for the first set is of a larger size than the other data sections.

64. The storage module of claim 58, wherein the common data for the first set is associated with the data in the plurality of data sections.

65. The storage module of claim 64, wherein the common data for the first set is a time of creation of the plurality of data sections.

66. The storage module of claim 58, wherein the common data for the first set is independent of the data of the plurality of data sections.

67. The storage module of claim 66, wherein the common data is a random number.

68. The storage module of claim 58, wherein the first set of data sections is received from a host device.

69. The storage module of claim 68, wherein the host device stores a second set of data sections, and wherein the common data is common to the first set but not to the second set.

70. The storage module of claim 68, wherein the first set of data sections comprises firmware for the storage module.

71. The storage module of claim 68, wherein the storage module receives computer-readable program code from the host device to generate a digital signature.

72. The storage module of claim 68, wherein the digital signature is generated using a key that is shared between the host device and storage module.

73. The storage module of claim 68, wherein the storage module is embedded in the host device.

74. The storage module of claim 68, wherein the storage module is removably connected to the host device.

75. The storage module of claim 58, wherein the digital signature is generated using a hash-based message authentication code (HMAC).
